(19) United States
(12) Patent Application Publication
(10) Pub. No.: US 2025/0178237 A1
(43) Pub. Date: Jun. 5, 2025

(54) BRIDGE MILLING MACHINE WITH CONVERTIBLE STRUCTURE

(71) Applicant: MARMO MECCANICA - S.P.A., MONSANO (AN) (IT)

(72) Inventor: Stefano AMAGLIANI, JESI (AN) (IT)

(21) Appl. No.: 18/966,310

(22) Filed: Dec. 3, 2024

(30) Foreign Application Priority Data
Dec. 5, 2023 (IT) 102023000025935

(51) Int. Cl. B28D 1/04; B28D 7/04

(52) U.S. Cl. CPC B28D 1/043; B28D 7/04

(57) ABSTRACT

Disclosed is a bridge milling machine for the machining of marble or stone slabs provided with two load-bearing sides between which there is a horizontal bench supporting the slabs to be machined under a multi-axis cutting head. Wherein said horizontal bench is connected to the two sides by a connection means suitable for being easily and quickly dismounted and remounted.

### CROSS-REFERENCE TO RELATED APPLICATIONS

Not applicable.

### BACKGROUND OF THE INVENTION

The present patent application for an industrial invention relates to a bridge milling machine with a convertible structure.

The peculiarities and advantages of the invention will become more apparent following a brief description of the prior technique and its main drawback.

The milling machine in question belongs to the type of milling machines suitable for being used to machine marble or stone slabs.

Currently, the milling machines that are used for such a purpose are provided with a horizontal table-technically referred to as “bench”—used to support the slab to be cut, which operates at the center of a metal frame comprising two sides-technically referred to as “walls”—that transversely support a horizontal beam-technically referred to as “bridge”—capable of making alternate travels between said sides, just like a bridge crane.

In turn, such a beam supports a sliding carriage that inferiorly supports a circular saw with 2, 3, 4 or 5 axes (depending on the end user's needs) suitable for interfering with the slab to be cut resting on the aforementioned bench.

Such an interaction between the circular saw, the sliding carriage along the bridge and the sliding bridge along the sides provides such a milling machine with great versatility of use and with the capability of cutting the slab with the depth and direction that are required from time to time.

A typical expression of the aforementioned technology is shown in the appended “Prior Art” drawing, wherein FIGS. 1 and 2 are detailed views of the structure of a traditional bridge milling machine, which is preferably made of strong metal sections.

With reference to the aforementioned figures, a traditional bridge milling machine (F) comprises:
a first side or “wall” (1a) and a second side or “wall” (1b) joined together by a rear side member (2) and a front side member (3) suitable for resting on the ground; wherein the rear side member (2) is immovably fixed between the sides (1a, 1b) at the rear area of the milling machine (F), whereas the front side member (3) is immovably fixed between the sides (1a, 1b) at the front area of the milling machine (F);
a beam (T) supported transversely at the top of the sides (1a, 1b), wherein said beam (T) is capable of sliding in alternate directions, remaining in parallel position, along said sides (1a, 1b);
a cutting head (G) supported by the beam (T) and capable of sliding in alternate directions along said beam (T); and
a bench (6) arranged in the space between said sides (1a, 1b) and said members (2, 3) and inferiorly to the beam (T); wherein said bench (6) has the function of supporting the slab (L) to be cut in a useful position to be reached by the aforesaid cutting head (G); it being also provided that said bench (6) inferiorly comprises a pair of bars (7) suitable for being fixed above the members rafters (2, 3).

In view of the above, it is pointed out that although, in FIGS. 1 and 2, the sides (1a, 1b) have a substantially grated metal structure, it is sometimes provided that said sides (1a, 1b) are reinforced with a central concrete panel.

Based on the previous description, it is precisely understood how a typical traditional milling machine (F) has a one-piece, cage-like metal structure, in the center of which the bench (6) for the slab (L) to be cut is provided.

The choice of giving the milling machine (F) such a one-piece structure is justified by the convenience and the speed with which such a heavy and bulky structure can be moved.

In fact, such a milling machine (F) can be conveniently attached and lifted, in a single move, every time it is necessary to move the milling machine, that is to say during the transfer from the place of manufacture to the place of installation, during the initial installation in the production plant or during a possible subsequent movement from one location to another in the production plant.

The additional advantage ensured by the adoption of such a one-piece structure is related to the fact that, in all the aforementioned possible handling operations, there is no change whatsoever in the position—i.e. the centering-of the bench (6) supporting the slabs (L) to be cut with respect to the other components of the milling machine (F), in a condition in which the cutting head (G) always maintains the capability to interfere with the slabs (L) to be cut, even in spite of any movement imposed on the milling machine (F).

A milling machine of the aforementioned one-piece type is disclosed and illustrated in US2015083103.

The one-piece milling machine (F) shown in FIGS. 1 and 2 and described in US2015083103 is actually impaired by a significant drawback that is related to the choice of giving such a one-piece structure to the milling machine.

In fact, it should be considered that the operation of any milling machine requires the assistance of an operator supervising the loading operations of the slab (L) to be cut onto the bench (6) and especially the manual unloading operations of the pieces obtained from cutting the slab.

There is no doubt that such operations-which require the operator to work all around the bench (6)—are impaired and made dangerous by the presence of the members (2, 3) which create an obstacle and an element of possible stumbling on the front of the milling machine (F) to the detriment of the operator who needs to repeatedly move closer and farther to/from the bench (6) during the movements of the milling machine (F) handling operations.

### SUMMARY OF THE INVENTION

Starting from such a critical observation of the prior art, the specific purpose of the present invention is to realize an innovative bridge milling machine that, while not renouncing the advantages ensured while moving by the adoption of a monolithic structure, once it is brought to the place of installation, is nevertheless capable of partially modifying its structure, precisely for the purpose of facilitating the access and movements of the operator in the space surrounding the bench that supports the slabs to be cut.

As it will be clarified below, such a solution greatly improves the ergonomics of the new milling machine in question and eliminates the aforementioned obstacle and risk factor that is currently encountered for the operator in traditional monolithic milling machines.

The abovementioned typical purpose of the invention was achieved in accordance with the features listed in the attached independent claim 1.

Advantageous embodiments of such an invention appear from the dependent claims.

### BRIEF DESCRIPTION OF DRAWINGS

For greater explanatory clarity, the description of the invention continues with reference to the additional appended drawings, which are for illustrative and non-limiting purposes only.

FIGS. 1 and 2 are detailed views of the structure of a traditional bridge milling machine.

FIGS. 3A, 3B, and 3C are views of a first embodiment of the new milling machine in question.

FIGS. 4A and 4B are views of a second embodiment of the new milling machine in question.

FIGS. 5A and 5B are front views of a third embodiment of the new milling machine in question.

### DETAILED DESCRIPTION OF THE INVENTION

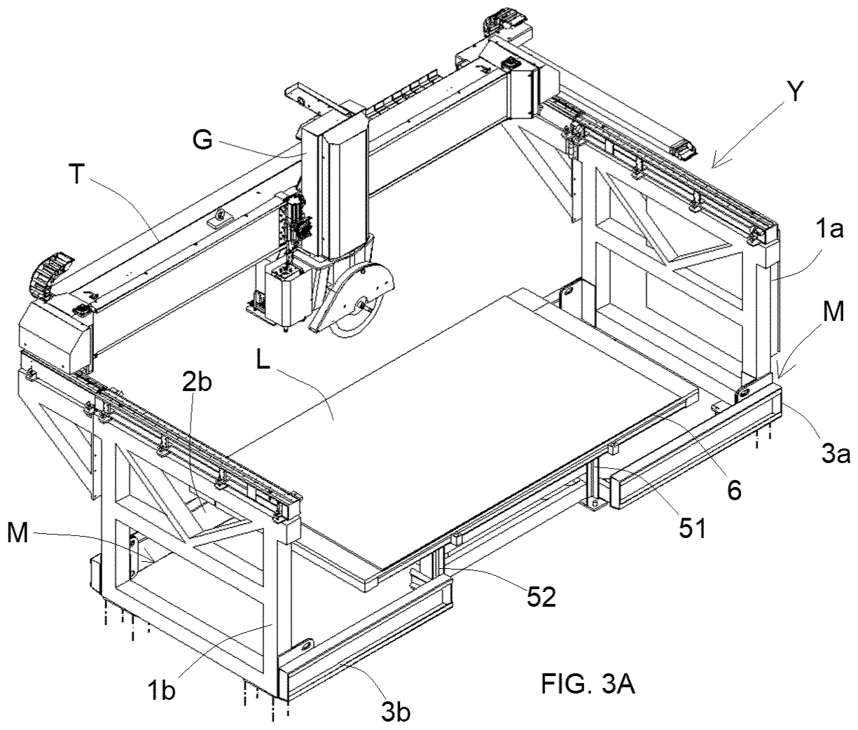

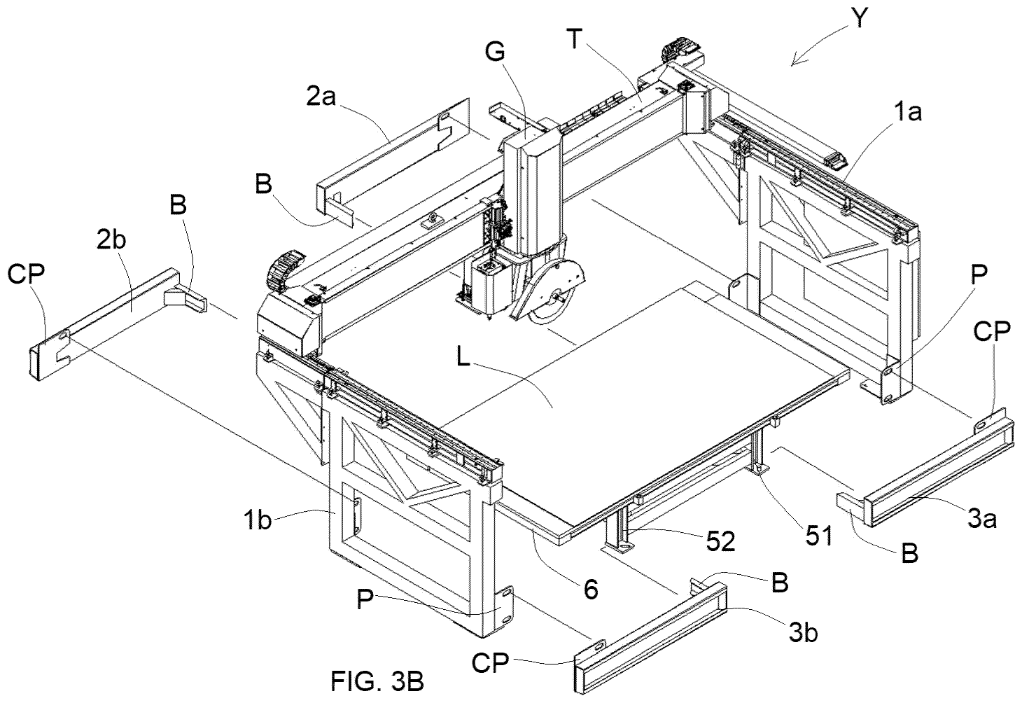

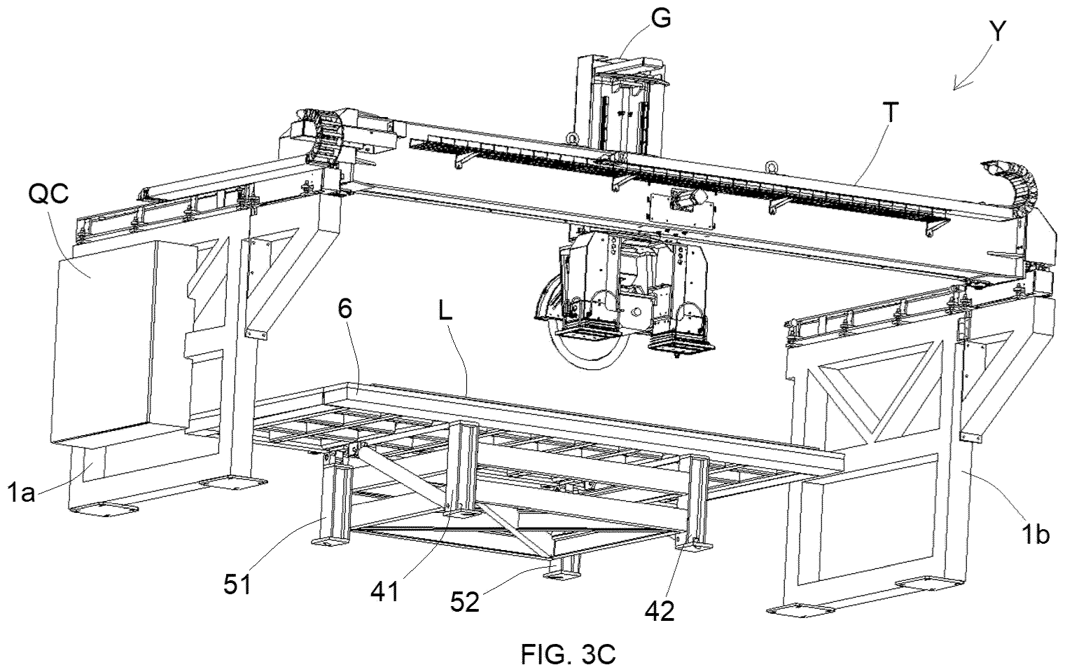

With reference to FIGS. 3A, 3B, 3C, 4A, 4B, 5A and 5B, the new milling machine according to the invention, which is comprehensively indicated with reference letter “Y”, is described below.

With reference to the appended figures, the new milling machine in question (Y) comprises:
a first side or “wall” (1a) and a second side or “wall” (1b);
a beam (T) supported transversely at the top of said sides (1a, 1b), wherein said beam (T) is capable of sliding in alternate directions along said sides (1a, 1b), while remaining parallel to itself;
a multi-axis cutting head (G) supported by the beam (T) and capable of sliding in alternate directions along said beam (T); and
a bench (6) arranged in the space comprised between said sides (1a, 1b) inferiorly to the beam (T); wherein said bench (6) supports the slab (L) to be cut in a useful position to be reached by said cutting head (G).

The bench (6) has supporting means (41, 42, 51, 52, 61, 62) resting on the ground below and supporting the bench (6). In view of the above, the bench (6) rests directly on the ground due to its aforementioned supporting means (41, 42, 51, 52, 61, 62).

Starting from such a traditional approach, the new milling machine (Y) has the peculiarity of adopting removable connection means (M) suitable for connecting the bench (6) to the two sides (1a, 1b). The removable connection means (M) provide the connection between the bench (6) and the sides (1a, 1b) by means of fast mounting/dismounting means, preferably pairs of bolts and nuts.

Precisely because of such a provision, as long as the connection means (M) are in operating position, the new milling machine (Y) can have a substantially monolithic structure that certainly proves to be advantageous for all occasions when the milling machine (Y) is to be transported or moved.

However, once such a milling machine (Y) has arrived at the place of destination, the possibility of removing the removable connection means (M) that connect the sides (1a, 1b) with the bench (6) easily and quickly in order to free up the operational space around the bench (6) proves to be equally advantageous.

Moreover, an additional significant advantage of such an innovative technology consists in the possibility to preserve the perfect centering of the bench (6) with respect to the general structure of the milling machine (Y), as long as the removable connection means (M) are in their operational position, and even after the removal of the removable connection means (M), precisely because of the “autonomous” ground support of the bench (6) provided by the supporting means (41, 42, 51, 52, 61, 62).

According to a first embodiment of the invention, which is shown in FIGS. 3A, 3B and 3C, the supporting means (41, 42, 51, 52, 61, 62) comprise a pair of rear legs (41, 42) and a pair of front legs (51, 52) for ground support, whereas said removable connection means (M) consist of a pair of side members (2, 3), namely a front side member (3) and a rear side member (2), each of them consisting of two separate segments (2a, 2b/3a, 3b), namely a first segment (2a, 3a) and a second segment (2b, 3b).

In particular, with reference to said front legs (51, 52), it is possible to distinguish a first front leg (51) in proximal position to the first side (1a) and a second front leg (52) in proximal position to the second side (1b).

Likewise, with reference to said rear legs (41, 42), it is possible to distinguish a first rear leg (41) in proximal position to the first side (1a) and a second rear leg (42) in proximal position to the second side (1b).

In such a situation, it is particularly provided that the first segment (2a) of the rear side member (2) is removably mounted between the first side (1a) and the first rear leg (41) of the bench (6), whereas the second segment (2b) of the rear side member (2) is removably mounted between the second rear leg (42) of the bench (6) and the second side (1b).

With reference to the front side member (3), it is similarly provided that the first segment (3a) is removably mounted between the first side (1a) and the first front leg (51) of the bench (6), whereas the second segment (3b) is removably mounted between the second side (1b) and the second front leg (52) of the bench (6).

Preferably, the mounting of the four segments (2a, 2b/3a, 3b) of the two side members (2, 3) in the aforementioned respective position is performed by means of bolts that can be easily removed, if necessary, as it will be better explained below.

In any case, because of the previous provisions, it is easy to understand the aforementioned versatility of the new milling machine in question (Y).

FIG. 3A shows the configuration assumed by the new milling machine (Y) in question during transportation and handling operations.

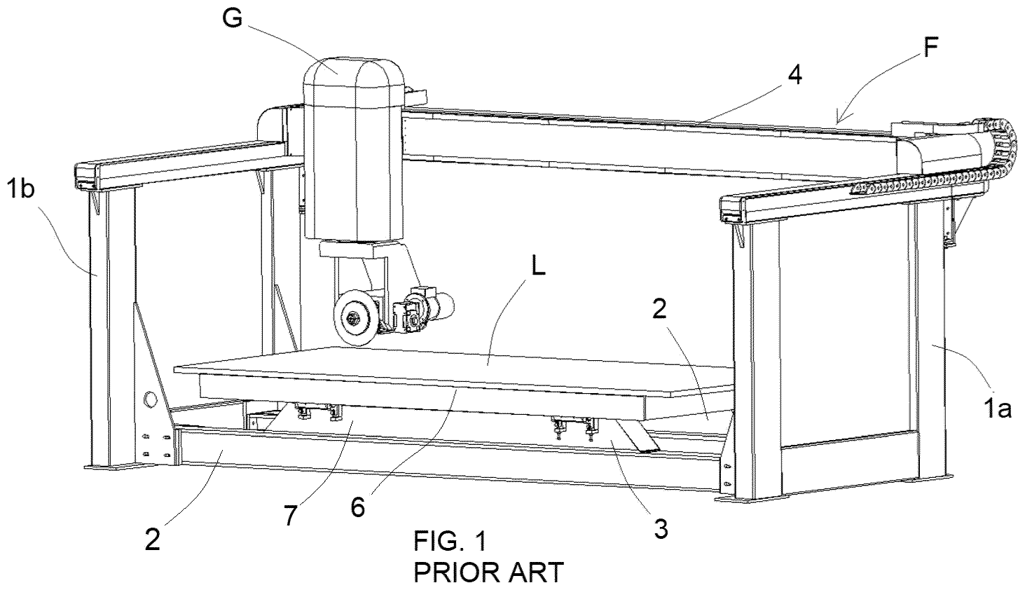

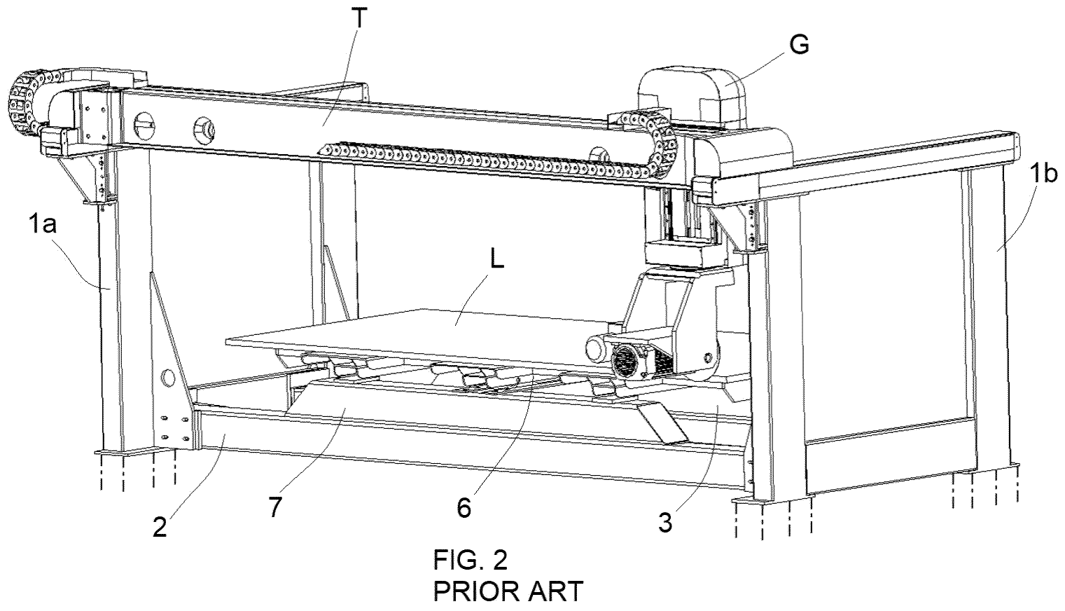

More specifically, in such a situation, the two pairs of segments (2a, 2b/3a, 3b) that make up the two side members (2, 3) are maintained in their operational arrangement between the sides (1a, 1b) and the legs (41, 42, 51, 52) of the bench (6), in a condition that gives the entire milling machine (Y) a substantially monolithic structure that is equivalent to that of a conventional milling machine (F) of the type shown in FIGS. 1 and 2.

However, once the new milling machine (Y) has been placed at its place of destination, as mentioned above, the two segments (3a, 3b) of the front side member (3) and the two segments (2a, 2b) of the rear side member (2) are disassembled and removed, in such a way to completely free the access in the direction of the bench (6) for the benefit of the operator in charge of the operation of the new milling machine in question (Y), as sequentially shown in FIGS. 3B and 3C.

Evidently, such a possibility is a consequence of the fact that, in spite of the removal of the two side members (2, 3), the bench (6) can still enjoy the stable ground support that is guaranteed by the pairs of legs (41, 42, 51, 52).

With specific reference to FIG. 3B, this description continues by illustrating a preferred solution adopted to enable the fast mounting/dismounting of the segments (2a, 2b/3a, 3b) that make up the two side members (2, 3).

Specifically, such an assembly solution provides that:
the four uprights of the sides (1a, 1b) are provided at ground level with four plates (P) arranged edgeways and facing the center of the milling machine (Y), wherein each of said plates (P) has through holes;
the four segments (2a, 2b/3a, 3b) of the two side members (2, 3) are provided at the outer end with a counter plate (CP) suitable for being exactly interfaced with the plate (P) provided in the respective upright of the respective side (1a, 1b); wherein said counter plate (CP) has at least one through hole suitable for being horizontally aligned with one of the aforementioned holes of the corresponding plate (P) for the purpose of installing a respective fixing bolt; and
the segments (2a, 2b/3a, 3b) of the two side members (2, 3) are provided at the outer end with an arm (B) facing the center of the milling machine (Y) suitable to abutting on the outside of the respective leg (41, 42, 51, 52) of the bench (6) in order to be stably attached by means of bolts suitable for being threaded and screwed into appropriate pairs of holes that are horizontally aligned and provided at each specimen of said arm (B) and respective leg (41, 42, 51, 52) of the bench (6).

With specific reference to FIG. 3C, it should be noted that, according to the preferred embodiment, the new milling machine in question (Y) is traditionally provided with a switchboard (QC) that is mounted on the outside of the first side (1a).

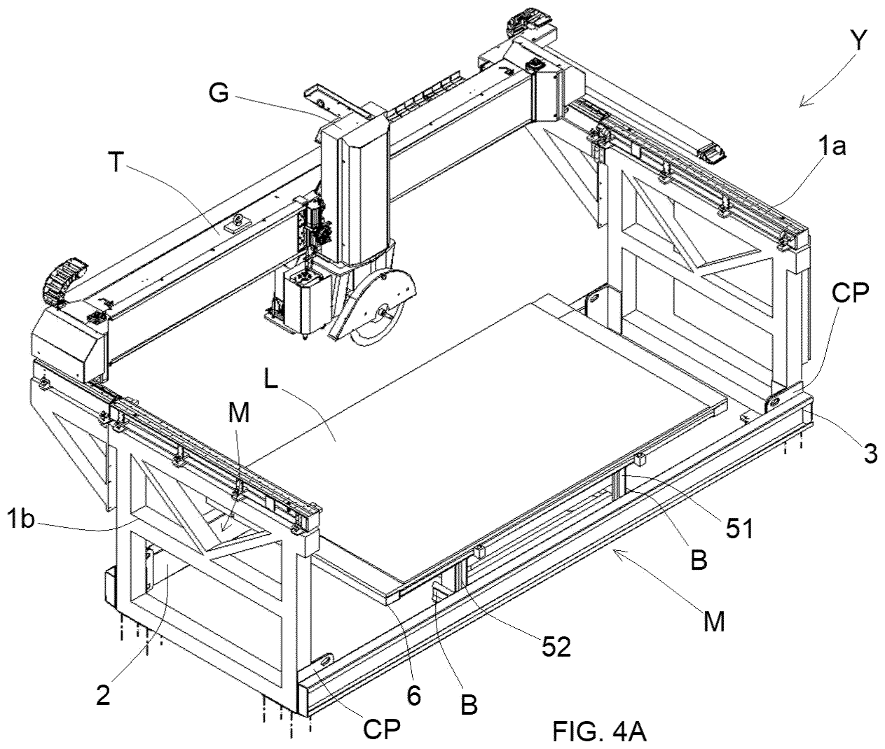

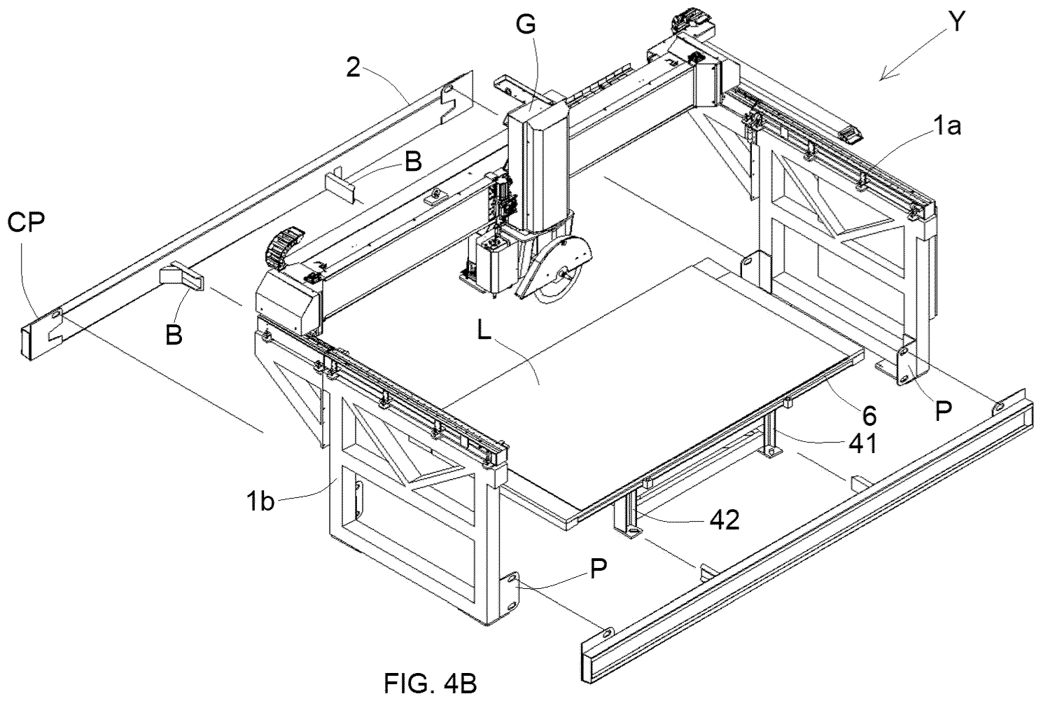

FIGS. 4A and 4B show a second preferred embodiment of the new milling machine in question (Y), wherein the supporting means (41, 42, 51, 52, 61, 62) comprise the aforementioned pairs of front legs (51, 52) and rear legs (41, 42) whereas the side members (2, 3)—which are in any case designed to be mounted by means of fast mounting/dismounting means-have a monolithic structure, renouncing the previous solution in which each side member is formed by two separate segments.

However, it should be considered that the two side members (2, 3) that are made in one piece take advantage of the same fast mounting/dismounting logic principle described with reference to the first embodiment of the invention.

At this regard, reference is made to the comparative observation of FIGS. 4A and 4B that respectively show the new milling machine (Y) in the position assumed as long as the two side members (2, 3) are mounted between the two sides (1a, 1b), and the milling machine (Y) in the position assumed following the removal of the two side members (2, 3).

The observation of the latter two Figures show that, also in such a case:
the four uprights of the two sides (1a, 1b) are provided at ground level with four plates (P) arranged edgeways and facing the center of the milling machine (Y), wherein each of said plates (P) is provided with through holes;
the two side members (2, 3) are provided at the ends with respective counter plates (CP) suitable for being exactly interfaced with the plates (P) provided in the sides (1a, 1b); wherein each of said counter plates (CP) has at least one through hole suitable for being horizontally aligned with one of the holes of the corresponding plate (P) for the purpose of installing a respective fixing bolt; and
the two side members (2, 3) are provided at the inner surface with two arms (B) facing the center of the milling machine (Y), and provided with through holes with a horizontal axis; wherein the two arms (B) of the rear side member (2) are suitable for being bolted to the side of the two rear legs (41, 42) of the bench (6), and wherein the two arms (B) of the front side member (3) are suitable for being bolted to the side of the two front legs (51, 52) of the bench (6) that are suitably provided with through holes with a horizontal axis.

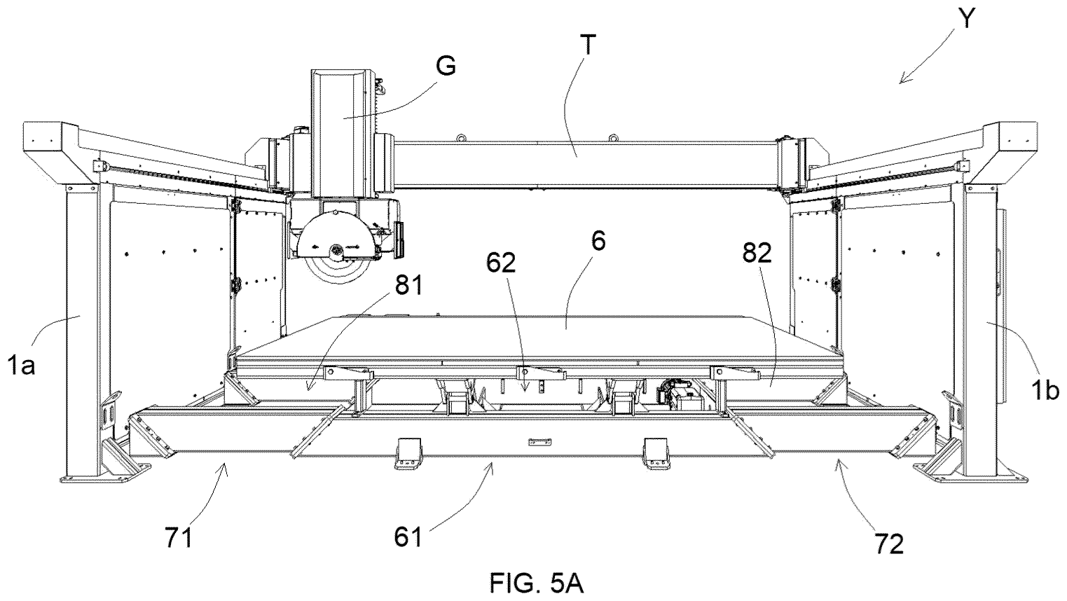

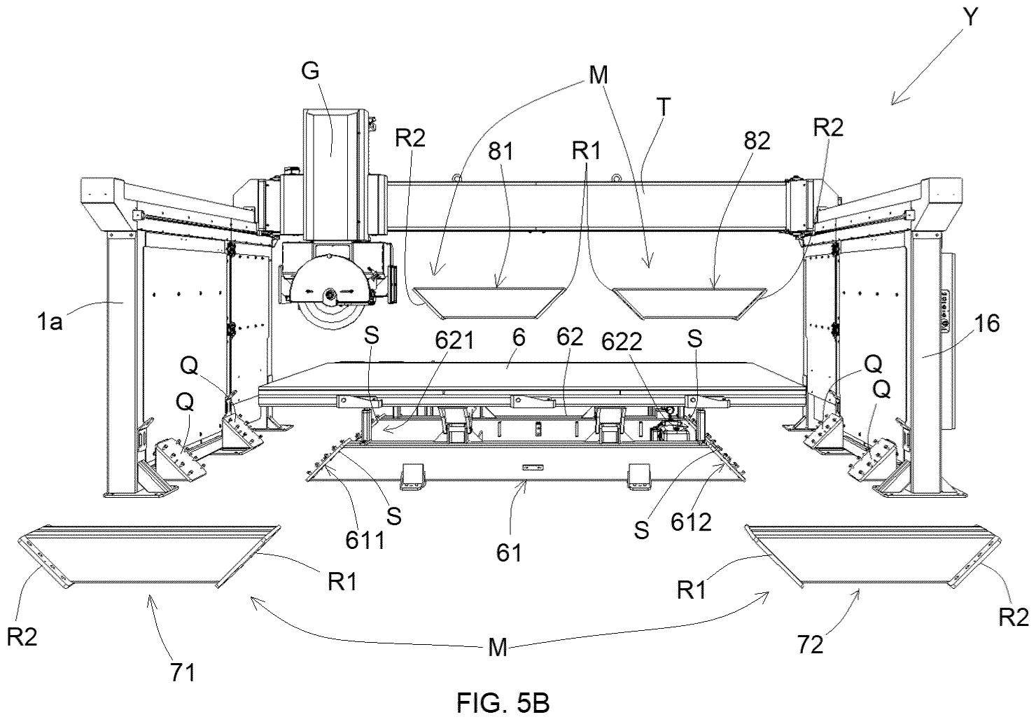

With reference now to FIGS. 5A and 5B, a third embodiment of the milling machine (Y) according to the invention is described below.

According to said third embodiment, the supporting means (41, 42, 51, 52, 61, 62) comprise a front support beam (61) and a rear support beam (62) whereas said removable connection means (M) comprise girders (71, 72, 81, 82), each one connecting one end of the support beam (61, 62) to a respective side (1a, 1b).

Specifically, each support beam (61, 62) comprises a first end (611, 621) facing the first side (1a) and a second end (612, 622) facing the second side (1b), said girders (71, 72, 81, 82) comprising:
a first front girder (71) suitable for being attached by means of fast mounting/dismounting means between said first side (1a) and said first end (611) of the front support beam (61);
a second front girder (72) suitable for being attached by means of fast mounting/dismounting means between said second side (1b) and said second end (612) of the front support beam (61);
a first rear girder (81) suitable for being attached by means of fast mounting/dismounting means between said first side (1a) and said first end (621) of the rear beam (62); and
a second rear girder (82) suitable for being attached by means of fast mounting/dismounting means between said second side (1b) and said second end (622) of the rear support beam (62).

Preferably, said fast mounting/dismounting means for said girders (71, 72, 81, 82) comprise:
four plates (Q) facing the center of the milling machine (Y), mounted at ground level on the uprights of the said sides (1a, 1b); wherein each of said plates ( ) has through holes;
two perforated flanges(S) formed at the ends of each support beam (61, 62);
one inner flange (R1) and one outer flange (R2) drilled for each girders (71, 72, 81, 82) obtained at the ends of the girders (71, 72, 81, 82).

The outer flange (R2) of each of said girders (71, 72, 81, 82) is suitable for being engaged and bolted to the corresponding perforated plate (Q) located on the upright of one of the sides (1a, 1b), and the inner flange (R1) of each of said girders (71, 72, 81, 82) is suitable for being engaged and bolted to the corresponding perforated flange(S) formed at the end of the support beam (61, 62).

Finally, it is reiterated that according to all the envisaged embodiments of the new milling machine (Y), the fast mounting/dismounting means cooperating with the connection means (M) preferably consist of pairs of bolts and nuts.

1. A bridge milling machine provided with a metal structure comprising:
a first side or wall and a second side or wall;
a beam supported transversely at a top of said sides, wherein said beam is capable of sliding in alternate directions along said sides;
a multi-axis cutting head supported by said beam, and capable of sliding in alternate directions along said beam;
a bench arranged in a space comprised between said sides inferiorly to the beam;
wherein said bench supports a slab to be cut in a position to be reached by said cutting head;
wherein said bench comprises supporting means resting on the ground and supporting the bench;
movable connection means connecting the bench to the sides and cooperating with fast mounting/dismounting means.

2. The bridge milling machine of claim 1, wherein said supporting means comprise:
a pair of rear legs, of which a first rear leg in proximal position to the first side and a second rear leg in proximal position to the second side; and
a pair of front legs, of which a first front leg in proximal position to the first side and a second front leg in proximal position to the second side.

3. The bridge milling machine of claim 1, wherein said supporting means comprise a front support beam and a rear support beam; wherein each support beam comprises a first end facing the first side and a second end facing the second side.

4. The bridge milling machine of claim 2, wherein said removable connection means comprise:
a rear side member suitable for being attached between said sides at a rear area of said bridge milling machine by means of fast mounting/dismounting means; wherein said rear side member is suitable for being attached to said rear legs of said bench by means of fast mounting/dismounting means;
a front side member suitable for being attached between said sides at a front area of said milling machine by means of means of fast mounting/dismounting means; wherein said front side members is suitable for being attached to said front legs of the bench by means of fast counting/dismounting means.

5. The bridge milling machine of claim 4, wherein said side members have a monolithic structure and wherein the fast mounting/dismounting means of said side members comprise:
four plates arranged edgeways and facing a center of the milling machine, mounted at ground level on the uprights of said sides; wherein each of said plates has through holes;
a counter plate mounted at the ends of said rear and front side members; wherein said counter plate is provided with through holes and is suitable for being interfaced and attached by means of bolts to a respective plate provided on the uprights of the sides;
two arms facing the center of the milling machine, each arm being provided with through holes with a horizontal axis; wherein the two arms of the rear side member are suitable to be bolted to the side of the two rear legs of the bench and wherein the two arms of the front side member are suitable for being bolted to the side of the two front legs of the bench;
wherein said legs are provided with holes with horizontal axis.

6. The bridge milling machine of claim 4, wherein said rear side member and said front side member comprise a first segment and a second segment; wherein the first segment of said rear side member is suitable for being attached by means of fast mounting/dismounting means between said first side and said first rear leg of the bench, whereas the second segment of said rear side member is suitable for being fixed by means of fast mounting/dismounting means between said second side and said second rear leg of the bench; and wherein the first segment of said front side member is suitable for being fixed by means of fast mounting/dismounting means between the first side and the first front leg of the bench, whereas the second segment of said front side member is suitable for being fixed by means of fast mounting/dismounting means between the second side and the second front leg of the bench.

7. The bridge milling machine of claim 6, wherein said fast mounting/dismounting means of said segments of the rear and front side members comprise:
four plates arranged edgeways and facing the center of the milling machine, mounted at ground level on the uprights of said sides; wherein each of said plates has through holes;
a counter plate mounted at an outer end of said segments of the rear and front side members; wherein said counter plate is provided with through holes and is suitable for being interfaced and bolted to a respective plate provided on the uprights of the sides;
an arm mounted at the inner end of said segments of the rear and front side members and facing the center of the milling machine; wherein said arm is provided with through holes with horizontal axis, and suitable for being interfaced and bolted to one of said legs, which are provided with holes with horizontal axis, of the bench.

8. The bridge milling machine of claim 3, wherein said removable connection means comprise:
a first front girder suitable for being attached by means of fast mounting/dismounting means between said first side and said first end of the front support beam;
a second front girder suitable for being attached by means of fast mounting/dismounting means between said second side and said second end of the front support beam;
a first rear girder suitable for being attached by means of fast mounting/dismounting means between said first side and said first end of the rear support beam;
a second rear girder suitable for being attached by means of fast mounting/dismounting means between said second side and said second end of the rear support beam.

9. The bridge milling machine of claim 8, wherein the fast mounting/dismounting means for said girders comprise:
four perforated plates facing the center of the milling machine and mounted at ground level on the uprights of said sides; wherein each of said plates has through holes;
two perforated flanges formed at the ends of each support beam;
one inner flange and one outer flange drilled for each girders obtained at the ends of the girders;
wherein the outer flange of each of said girders is suitable for being engaged and bolted to the perforated plate located on the upright of one of the sides, and said inner flange of each of said girders is suitable for being engaged and bolted to the perforated flange formed at the end of the support beam.
